(19) United States
(12) Patent Application Publication
(10) Pub. No.: US 2013/0021905 A1
(43) Pub. Date: Jan. 24, 2013

(54) CONTROLLING TRAFFIC FLOW TEMPLATE GENERATION

(71) Applicant: Mirko Schramm, Berlin (DE)

(72) Inventor: Mirko Schramm, Berlin (DE)

(73) Assignee: NOKIA SIEMENS NETWORKS OY, Espoo (FI)

(21) Appl. No.: 13/578,897

(22) PCT Filed: Jan. 12, 2010
(86) PCT No.: PCT/EP10/50262

§ 371 Date: Aug. 14, 2012

(51) Int. Cl. H04L 12/24; H04L 12/14

(52) U.S. Cl. 370/235

(57) ABSTRACT

It is indicated which filters are to be used for a traffic flow template generation, in rules informing a communications network about resources authorized for a user of the communications network. A gateway combines the rules to a bearer providing access to the communications network, and generates a traffic flow template for the bearer out of filters which are indicated to be used for traffic flow template generation for the bearer in the rules.

The present invention relates to apparatuses and methods for controlling traffic flow template (TFT) generation.

An EPC (Evolved Packet Core) architecture is specified in 3GPP (Third Generation Partnership Project) TS 23.401 and TS 23.402. Therein, the procedures for session management, i.e. establishment, modification and deactivation of EPS (Evolved Packet System) bearers, are described. Control of the session management is typically provided by a PCC (Policy and Charging Control) functionality which is described in 3GPP TS 23.203, for example. Unspecified local policy, i.e. configuration data and proprietary logic, at a PGW (PDN (Packet Data Network) Gateway) may be applied as well but this is usually not sufficient if advanced and dynamic services have to be supported.

If PCC is deployed by an operator, a PCRF (Policy and Charging Rules Function) provides PCC rules to the PGW (and in case of a PMIP (Proxy Mobile Internet Protocol) based EPC, the PCRF provides QoS (Quality of Service) rules to an SGW (Serving Gateway)), which inform the EPC about what resources are authorized for a user. The PGW (or SGW respectively) can then combine PCC rules with identical QCI (QoS Class Identifier) and ARP (Allocation/Retention Priority) to bearers and initiate required session management procedures to allocate resources. Part of this functionality is a generation of a TFT for an EPS bearer out of SDF (Service Data Flow) filters that belong to the PCC rule(s) which have been bound to this EPS bearer.

A UE (User Equipment) is connected to the EPC via one or more PDN (Packet Data Network) connections. Each PDN connection comprises one default EPS bearer and may have in addition several dedicated EPS bearers. Each of the dedicated EPS bearers is required to have a TFT that defines traffic (i.e. IP flows) which are allowed to pass through this EPS bearer. While the PGW has the SDF filters in the PCC rules for this purpose, the TFT is the only means to tell the UE how to use the dedicated EPS bearers.

The present invention aims at providing a dynamic and flexible TFT generation.

This is achieved by the subject matters as defined in the appended claims.

According to an embodiment of the invention, it is indicated which filters are to be used for a traffic flow template generation, in rules informing a communications network about resources authorized for a user of the communications network. A gateway combines the rules to a bearer providing access to the communications network, and generates a traffic flow template for the bearer out of filters which are indicated to be used for traffic flow template generation for the bearer in the rules.

In the following the present invention will be described by way of embodiments thereof taking into account the accompanying drawings, in which:

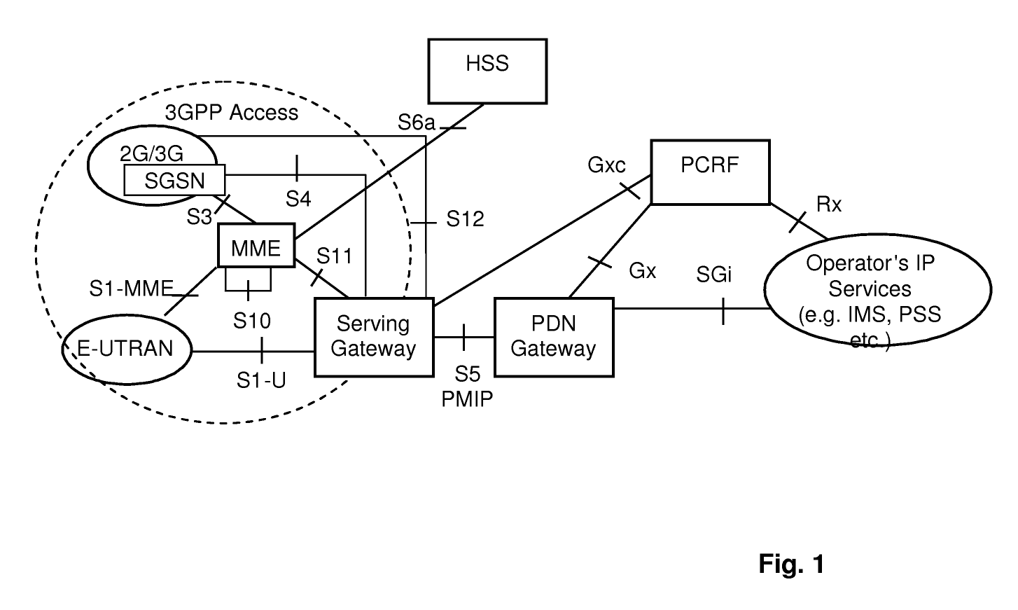

FIG. 1 shows a diagram of an EPS architecture to which the invention may be applied according to an embodiment thereof.

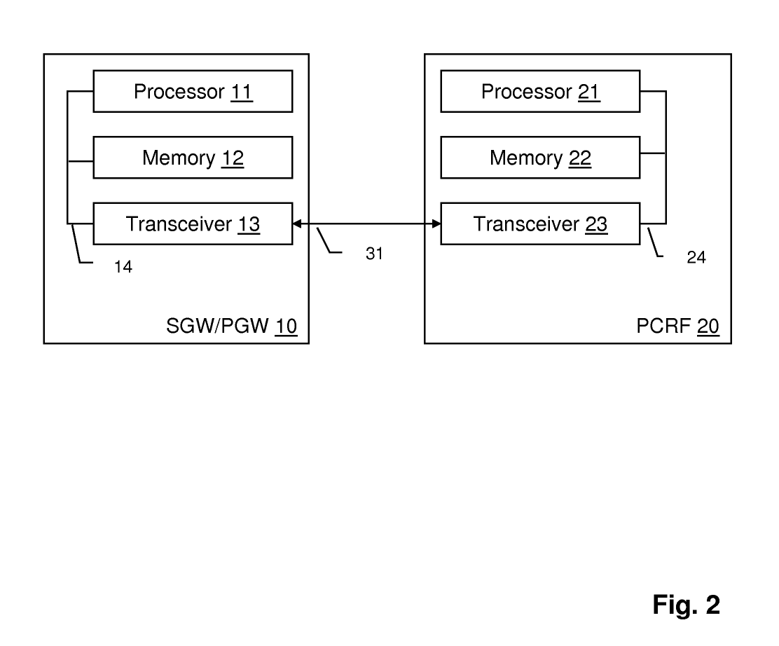

FIG. 2 shows a schematic block diagram illustrating a structure of a gateway apparatus and a structure of an apparatus comprising a policy and charging control function according to an embodiment of the invention.

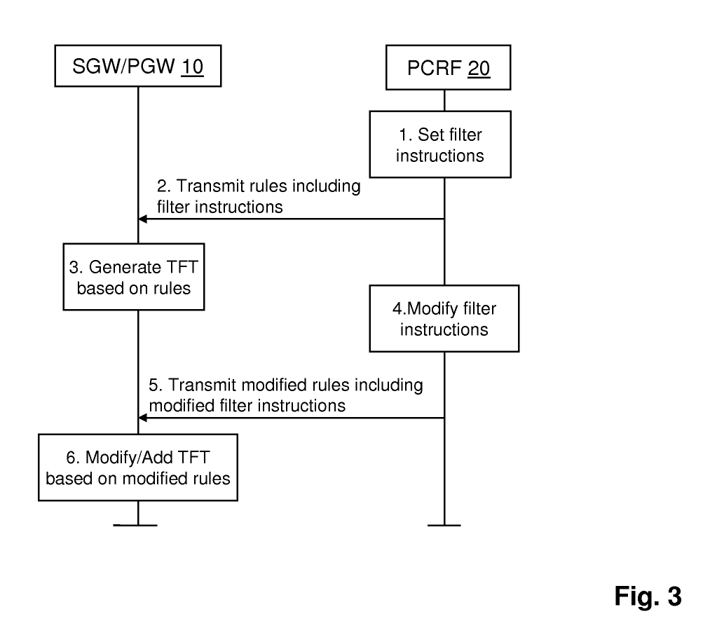

FIG. 3 shows a signaling diagram according to an embodiment of the invention.

FIG. 1 shows an EPS architecture comprising a serving gateway (SGW) and a PDN gateway (PGW) which are connected to a PCRF via a Gxc and Gx interface, respectively.

Currently, it is up to the PGW (or SGW respectively) implementation to generate the TFT out of the SDF filters. As the PGW does typically not know much about a user of the EPS, his services or operator policies, a simple and straight-forward TFT generation logic may be applied. For example, the

PGW may simply copy the SDF filters from the PCC rule(s) into the TFT.

However, there are several disadvantages when applying a simple TFT generation logic:
As the number of filters per TFT is limited to 15, the usage of SDF filters that are only relevant for the downlink (e.g. to achieve a differentiated charging) within the TFT increases the risk of session management failure, or would require the establishment of another EPS bearer without a real need.
The usage of pre-defined PCC rules with non-standardized filters (that cannot be mapped to the TFT or would lead to a wrong match) would be strongly limited.
The TFT treatment for the default EPS bearer remains unspecified (or requires proprietary solutions), i.e. whether to generate a TFT for the default EPS bearers and which of the possible SDF filters (of PCC rule(s) that are installed for the default EPS bearer) to apply for the generation of the TFT. While it is required to have a TFT for every dedicated EPS bearer, it is also possible to add a TFT to the default EPS bearer. This may be of interest if the operator wants to restrict the usage of this bearer to certain types of traffic (e.g. in case of an emergency PDN connection) or the user/operator has an interest in applying a certain fire-walling functionality.

Thus, there are at least two situations of special interest:
The addition (or removal) of a TFT to the default EPS bearer.
The generation of the TFT from pre-defined PCC rules.

Currently, in these two situations it is not obvious whether and how to generate the TFT. While the PCC rules (with their SDF filters) are always applied at the PGW, a TFT may or may not be required for the EPS bearer.

According to an embodiment of the invention, the PGW (or SGW respectively) is provided with explicit instructions about which of the SDF filters are to be used for the TFT generation and which not.

FIG. 2 shows a schematic block diagram illustrating a structure of a gateway apparatus such as an SGW/PGW (i.e. a SGW and/or PGW) 10 and a structure of an apparatus comprising a policy and charging control function such as a PCRF 20 according to an embodiment of the invention. The SGW/PGW 10 and PCRF 20 shown in FIG. 2 may be applied as the SGW, PGW and PCRF shown in FIG. 1.

The SGW/PGW 10 comprises a processor 11, a memory 12 which may store a program and a transceiver 13 which are connected via a bus 14. The PCRF 20 comprises a processor 21, a memory 22 which may store a program and a transceiver 23 which are connected via a bus 24. The SGW/PGW 10 may communicate with the PCRF 20 through a link 31 between the transceivers 13, 23.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

At least one of the programs stored in the memories 12, 22 is assumed to include program instructions that, when executed by the associated processor, enable the apparatuses (the SGW/PGW and/or the PCRF) to operate in accordance with the exemplary embodiments of this invention, as detailed below. The processors 11, 21 also are assumed to each include a modem to facilitate communication over the (hardwire) link 31.

The exemplary embodiments of this invention may be implemented by computer software stored in the memory 12, 22 and executable by the processor 11, 21, or by hardware, or by a combination of software and/or firmware and hardware in any or all of the devices shown.

The memories 12, 22 may be of any type suitable to the local technical environment and may be implemented using any suitable data storage technology, such as semiconductor-based memory devices, magnetic memory devices and systems, optical memory devices and systems, fixed memory and removable memory. The processors 11, 21 may be of any type suitable to the local technical environment, and may include one or more of general purpose computers, special purpose computers, microprocessors, digital signal processors (DSPs) and processors based on a multi-core processor architecture, as non-limiting examples.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

According to an embodiment of the invention, it is indicated in rules informing a communications network (e.g. an EPC) about resources authorized for a user of the communications network, which filters are to be used for a traffic flow template generation. For example, the processor 21 indicates in PCC rules to be submitted to the SGW/PGW 10, which one(s) of SDF filters in the PCC rules should be used for the TFT generation and which one(s) should not be used for the TFT generation. Alternatively or in addition, it is indicated in

PCC rules pre-configured in the SGW/PGW 10 which one(s) of SDF filters in the PCC rules should be used for the TFT generation and which one(s) should not be used for the TFT generation.

Thus, an operator of the SGW/PGW 10 and the PCRF 20 are enabled to provide explicit instructions to the SGW/PGW, about which of the SDF filters are to be used for the TFT generation and which not. The PCRF 20 may submit these instructions via the link 31 which may comprise the Gx or Gxc interface shown in FIG. 1.

A possible implementation of such an explicit instruction is to enhance SDF filter encoding by appropriate information. According to an embodiment of the invention, it is indicated, e.g. by the processor 21, that a filter is to be used for the traffic flow template generation by adding information to the filter and/or by separating filters to be used for the traffic flow template generation from filters not to be used for the traffic flow template generation based on internet protocol flow attribute value pairs. For example, every SDF filter may be extended by e.g. a flag. Alternatively, IP flow AVPs (Attribute Value Pairs) may be embedded into a structure that separates into SDF filters to be used for the TFT and those not to be used. Based on the explicit instruction, the SGW/PGW 10 knows whether to apply an SDF filter for the TFT generation or not.

The instruction about which of the SDF filters are to be used for the TFT generation and which not may be provided by the PCRF 20 for dynamic PCC rules, and may be part of pre-defined PCC rules that are preconfigured in the SGW/PGW 10.

It may be indicated, e.g. by the processor 21, which filters are to be used for the traffic flow template generation for a bearer providing access to the communications network.

Moreover, the indication of which filters are to be used for the traffic flow template generation may be modified, e.g. by the processor 21.

The processor 11 of the SGW/PGW 10 combines rules informing a communications network about resources authorized for a user of the communications network to a bearer providing access to the communications network, and generates a traffic flow template for the bearer out of filters which are indicated to be used for traffic flow template generation for the bearer in the rules. That is, the processor may combine PCC rules with identical QCI and ARP, which have been received from the PCRF 20 or which are pre-configured in the SGW/PGW 10, to an EPS bearer and generate a TFT for the EPS bearer out of the SDF filters that belong to the PCC rule(s) which have been bound to this EPS bearer and that are indicated to be used for the TFT generation.

The processor 11 may determine that a filter is indicated to be used for the traffic flow template generation from information added to the filter and/or from a structure separating filters to be used for the traffic flow template generation from filters not to be used for the traffic flow template generation based on internet protocol flow attribute value pairs.

The processor 11 may add, modify or remove the traffic flow template in response to a change of the indication of which filters are to be used for the traffic flow template generation. For example, the processor 11 may add or remove the traffic flow template in case the bearer is a default bearer, based on the indication of which filters are to be used for the traffic flow template generation.

Thus, according to an embodiment of the invention, a dynamic assignment/removal of a TFT to the default EPS bearer is enabled. All initially provided PCC rules for the default EPS bearer may have the instruction to not apply the SDF filters for a TFT generation. Consequently, the SGW/PGW 10 does not generate a TFT for the default EPS bearer. If required, the installed PCC rules can be modified later on e.g. by the PCRF 20 by setting the instruction for some or all of the SDF filters and this triggers the SGW/PGW 10 to modify the default EPS bearer by adding a TFT.

With this explicit instruction about which of the SDF filters are to be used for the TFT generation and which not, the SGW/PGW 10 can be controlled with regard to which SDF filters are to be used within the TFT of the bearer. This minimizes the risk of TFT operation failure due to the limitation to 15 TFT filters per EPS bearer as well as the number of EPS bearers that are required. Furthermore, unnecessary session management signaling can be avoided in case of SDF filter changes that are only relevant for the downlink.

In addition, the usability of pre-defined PCC rules is increased as non-standardized filters can be treated separately from the TFT filters.

And finally, a control mechanism for the TFT of the default EPS bearer is defined.

In other words, the implementation of the SGW/PGW (regarding the generation of the TFT) becomes simpler due to the explicit instruction in the PCC rules. Furthermore, a number of potential error scenarios can be avoided or at least their occurrence minimized. Finally, a mechanism for the control of the TFT usage for the default EPS bearer becomes available.

FIG. 3 shows a signaling diagram illustrating signaling between the SGW/PGW 10 and the PCRF 20 according to an embodiment of the invention.

In a first step 1 the PCRF 20 sets filter instructions, e.g. SDF filter instructions. That is, it is indicated in rules informing a communications network (e.g. an EPC) about resources authorized for a user of the communications network (e.g. PCC rules) which filters are to be used for a traffic flow template generation. It may be indicated which filters are to be used for the traffic flow template generation for a bearer providing access to the communications network. The rules may comprise dynamic policy and charging control rules. The filter instructions may be implemented by adding information to the filter and/or separating filters to be used for the traffic flow template generation from filters not to be used for the traffic flow template generation based on internet protocol flow attribute value pairs.

In a communication 2 the PCRF 20 transmits the rules including the filter instructions to the SGW/PGW 10.

In a step 3 the SGW/PGW 10 generates a TFT based on the received rules. That is, rules are combined to a bearer providing access to the communications network, and the TFT for the bearer is generated out of the filters based on the filter instructions in the rules.

For example, in a step 4 the PCRF 20 may modify the filter instructions, and transmit modified rules including the modified filter instructions to the SGW/PGW 10 in a communication 5. Thereupon, the SGW/PGW 10 may add, modify or remove the traffic flow template. In case the bearer is the default bearer, the traffic flow template may be added or removed in response to the received modified filter instructions.

According to an embodiment of the invention, an apparatus, such as the PCRF 20 shown in FIG. 2, comprises indicating means for indicating which filters are to be used for a traffic flow template generation, in rules informing a communications network about resources authorized for a user of the communications network. The indicating means may comprise the processor 21.

The indicating means may indicate which filters are to be used for the traffic flow template generation for a bearer providing access to the communications network.

The rules may comprise at least one of dynamic policy and charging control rules.

The apparatus may comprise adding means for, when it is to be indicated by the indicating means that a filter is to be used for the traffic flow template generation, adding information to the filter, and/or separating means for separating filters to be used for the traffic flow template generation from filters not to be used for the traffic flow template generation based on internet protocol flow attribute value pairs. The adding means and the separating means may comprise the processor 21.

The apparatus may comprise modifying means for modifying the indication of which filters are to be used for the traffic flow template generation. The modifying means may comprise the processor 21.

According to an embodiment of the invention, an apparatus, such as the SGW/PGW 10 shown in FIG. 2, comprises combining means for combining rules informing a communications network about resources authorized for a user of the communications network to a bearer providing access to the communications network, and generating means for generating a traffic flow template for the bearer out of filters which are indicated to be used for traffic flow template generation for the bearer in the rules. The combining means and the generating means may comprise the processor 11.

The apparatus may comprise adding means and/or modifying means and/or removing means for adding or modifying or removing the traffic flow template in response to a change of the indication of which filters are to be used for the traffic flow template generation. The adding means, modifying means and removing means may comprise the processor 11.

The adding means/removing means may add/remove the traffic flow template in case the bearer is a default bearer, based on the indication of which filters are to be used for the traffic flow template generation.

The rules may comprise at least one of dynamic policy and charging control rules and pre-defined policy and charging control rules preconfigured in the apparatus such as the SGW/PGW 10 shown in FIG. 2.

The apparatus may comprise determining means for determining that a filter is indicated to be used for the traffic flow template generation from information added to the filter and/or from a structure separating filters to be used for the traffic flow template generation from filters not to be used for the traffic flow template generation based on internet protocol flow attribute value pairs. The determining means may comprise the processor 11.

It is to be understood that the above description is illustrative of the invention and is not to be construed as limiting the invention. Various modifications and applications may occur to those skilled in the art without departing from the true spirit and scope of the invention as defined by the appended claims.

1. An apparatus, comprising:
a processor configured to indicate which filters are to be used for a traffic flow template generation, in rules informing a communications network about resources authorized for a user of the communications network.

2. The apparatus of claim 1, wherein the processor is configured to indicate which filters are to be used for the traffic flow template generation for a bearer providing access to the communications network.

3. The apparatus of claim 1, wherein the rules comprise dynamic policy and charging control rules.

4. The apparatus of claim 1, wherein the processor is configured to indicate that a filter is to be used for the traffic flow template generation by adding information to the filter and/or by separating filters to be used for the traffic flow template generation from filters not to be used for the traffic flow template generation based on internet protocol flow attribute value pairs.

5. The apparatus of claim 1, wherein the processor is configured to modify the indication of which filters are to be used for the traffic flow template generation.

6. An apparatus, comprising:
a processor configured to combine rules informing a communications network about resources authorized for a user of the communications network to a bearer providing access to the communications network, and generate a traffic flow template for the bearer out of filters which are indicated to be used for traffic flow template generation for the bearer in the rules.

7. The apparatus of claim 6, wherein the processor is configured to add, modify or remove the traffic flow template in response to a change of the indication of which filters are to be used for the traffic flow template generation.

8. The apparatus of claim 6, wherein the processor is configured to add or remove the traffic flow template in case the bearer is a default bearer, based on the indication of which filters are to be used for the traffic flow template generation.

9. The apparatus of claim 6, wherein the rules comprise at least one of dynamic policy and charging control rules and pre-defined policy and charging control rules preconfigured in the apparatus.

10. The apparatus of claim 6, wherein the processor is configured to determine that a filter is indicated to be used for the traffic flow template generation from information added to the filter and/or from a structure separating filters to be used for the traffic flow template generation from filters not to be used for the traffic flow template generation based on internet protocol flow attribute value pairs.

11. A method, comprising:
indicating which filters are to be used for a traffic flow template generation, in rules informing a communications network about resources authorized for a user of the communications network.

12. The method of claim 11, wherein the indicating comprises indicating which filters are to be used for the traffic flow template generation for a bearer providing access to the communications network.

13. The method of claim 11, wherein the rules comprise dynamic policy and charging control rules.

14. The method of claim 11, wherein the indicating comprises adding information to the filter and/or separating filters to be used for the traffic flow template generation from filters not to be used for the traffic flow template generation based on internet protocol flow attribute value pairs.

15. The method of claim 11, comprising modifying the indication of which filters are to be used for the traffic flow template generation.

16. A method, comprising:
combining rules informing a communications network about resources authorized for a user of the communications network to a bearer providing access to the communications network; and
generating a traffic flow template for the bearer out of filters which are indicated to be used for traffic flow template generation for the bearer in the rules.

17. The method of claim 16, comprising adding, modifying or removing the traffic flow template in response to a change of the indication of which filters are to be used for the traffic flow template generation.

18. The method of claim 16, comprising adding or removing the traffic flow template in case the bearer is a default bearer, based on the indication of which filters are to be used for the traffic flow template generation.

19. The method of claim 16, wherein the rules comprise at least one of dynamic policy and charging control rules and pre-defined policy and charging control rules preconfigured in a gateway.

20. The method of claim 16, comprising:
determining that a filter is indicated to be used for the traffic flow template generation from information added to the filter and/or from a structure separating filters to be used for the traffic flow template generation from filters not to be used for the traffic flow template generation based on internet protocol flow attribute value pairs.

21. A computer program product including a program for a processor, comprising software code portions for performing the steps of claim 11, when the program is run on the processor.

22. The computer program product according to claim 21, wherein the computer program product comprises a computer-readable medium on which the software code portions are stored.

23. The computer program product according to claim 21, wherein the program is directly loadable into an internal memory of the processor.
